(19) United States
(12) Patent Application Publication
(10) Pub. No.: US 2003/0066430 A1
(43) Pub. Date: Apr. 10, 2003

(54) Method and apparatus for preparing hot beverages

(76) Inventors: Nicola Bitar, Oberriet (CH); Mariano Turi, Zurich (CH)

Correspondence Address: Paul J. Maginot, Maginot Moore & Bowman, Bank One Center/Tower, 111 Monument Circle, Suite 3000, Indianapolis, IN, 46204-5115, US

(21) Appl. No.: 10/265,748

(22) Filed: Oct. 7, 2002

(30) Foreign Application Priority Data
Oct. 9, 2001 (CH) 1926/01
Apr. 23, 2002 (CH) 0689/02

(51) Int. Cl. A47J 31/00

(52) U.S. Cl. 99/275; 99/279

(57) ABSTRACT

The invention provides a method of preparing hot beverages by brewing up a particulate substance extractable by means of water. Thereby, the substance received in a brewing chamber is brewed up by brewing water that has a temperature above the normal boiling point of water, preferably 110° to 130° C., but still is in the fluid state of matter. The thus brewed beverage is cooled to a temperature below the normal boiling point of water before it flows to a beverage outlet. A significant advantage of this method is that the substance is much more efficiently extracted. For cooling the thus brewed beverage, preferably a heat exchanger is used through which fresh, not yet heated brewing water flows to thereby cool it.

### BACKGROUND OF THE INVENTION

The present invention refers to a method of preparing hot beverages by brewing up a particulate substance extractable by means of water as well as to an apparatus for preparing hot beverages by brewing up a particulate substance extractable by means of water.

Methods of preparing hot beverages by brewing a particulate substance that can be extracted by means of water are well known in the art in a great number of different varieties. As a typical example, reference can be made to so-called espresso coffee machines in which ground coffee powder is filled into a brewing chamber. The coffee powder is compacted in the brewing chamber and, thereafter, hot brewing water is led under pressure through the compacted coffee powder to extract it and to thereby prepare a coffee beverage.

In the case of conventional espresso coffee machines, the hot water flowing under pressure through the coffee powder received in the brewing chamber has a temperature of between appr. 85° and 98° C. In other words, the temperature of the hot brewing water flowing through the coffee powder received in the brewing chamber is below 100° C. in all known espresso coffee machine available on the market nowadays. The reason is that all experts are of the opinion that the taste of the final coffee beverage is impaired if the brewing water flowing under pressure through the coffee powder received in the brewing chamber has a temperature of more than 100° C. because, in such a case, bitterly tasting ingredients are said to be extracted from the coffee powder.

### PRIOR ART

The document EP 0,592,943 discloses a household espresso coffee machine, comprising a container for receiving fresh water, a heating assembly located below the fresh water container, a brewing chamber for receiving the ground coffee powder and a pump for feeding heated water from the container to the brewing chamber. The water received in the container is heated to a temperature of between 93° and 97° C. The hot water is fed by means of the pump from the container to the brewing chamber where it is pressed through the coffee powder with the desired temperature of between 93° and 97° C. Finally, from the brewing chamber, the final hot coffee beverage flows into a receiving container.

U.S. Pat. No. 4,287,817 discloses a conventional coffee machine having a filter basket or a similar brewing means for an essentially pressure-less brewing of the coffee powder. The coffee machine is provided with a boiler comprising a hot water conduit connected to the bottom of the boiler and a steam conduit connected to an upper part of the boiler, the latter one opening up to a separate steam outlet. The particularity of this coffee machine is seen in the fact that the boiler can produce both hot water and steam. In the introductory portion of the above mentioned U.S. Patent, it is mentioned that coffee machines are known in the art in which the coffee powder comes into contact with steam or brewing water that has been heated beyond the normal boiling point. However, as far as the temperature of the brewing water during its flowing through the coffee powder is concerned, the above mentioned U.S. Patent does not contain any detailed suggestions.

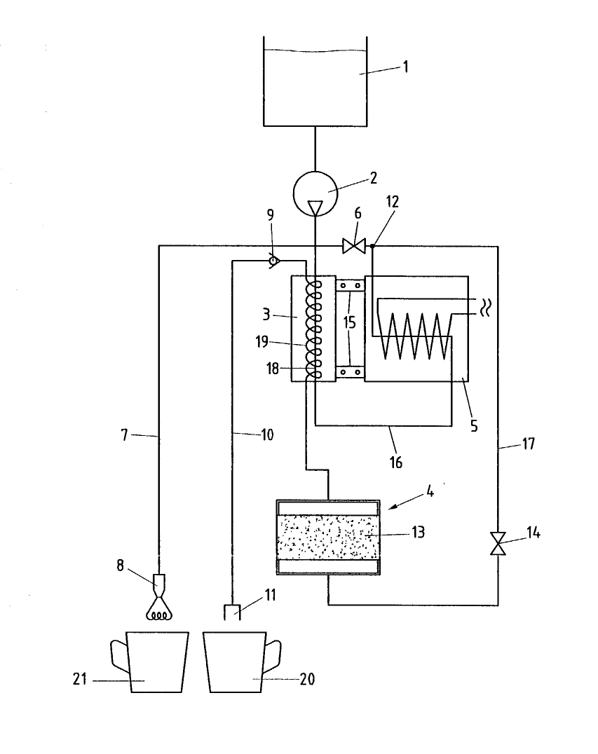

The document EP 0,812,559 discloses a coffee machine in which a pressure piston is located above the real brewing chamber; the pressure piston is adapted to specifically pressurize the brewing water for brewing the coffee powder. A control valve is located between the brewing chamber and the pressure piston, serving for performing the brewing operation stepwise, whereby, in a first step, the coffee powder is moistened and, in a second and a third step, the coffee powder is extracted. Even if it is mentioned that the brewing water is brought to an elevated temperature, there is no suggestion to rise the temperature of the brewing water above the normal boiling point. FIG. 2 of this document shows a brewing device designed according to the known state of the art. The brewing device comprises a first water heater and a second water heater, the latter one having a lower capacity than the first one. That additional, second water heater is designed to heat a small volume of water to a temperature of 180° C. The related description explains that, in a first step, this small volume of water heated to a temperature of 180° C. is supposed to moisten the coffee powder received in the brewing chamber with a mixture of water and steam. However, no further suggestions are given in this document as far as the real brewing operation is concerned.

Finally, the document EP 0,934,719 discloses a conventional coffee machine having a manually insertable filter holder. The basic idea of the invention is seen in the fact that, in a first pre-brewing phase, the overpressure of the water heated to a temperature of 120° C. is used to feed a small volume of brewing water into the coffee powder to moisten it. After a period of 2 to 8 seconds, a valve is opened with the result that fresh water fed by a pump flows through a boiler, in which it is heated, to the coffee powder received in the filter holder to extract the coffee powder and to thereby prepare the coffee beverage. Concerning the temperature of the brewing water flowing through the coffee powder received in the filter holder, no details or suggestions are contained in the above mentioned U.S. Patent.

Thus, it can be summarized that in all the coffee machines disclosed in the documents discussed herein above the brewing water flows through the coffee powder with a temperature that is below the normal boiling point of water.

### OBJECTS OF THE INVENTION

Thus, it is an object of the invention to provide a method of and an apparatus for preparing hot beverages by brewing up a particulate substance extractable by means of water in which the particulate substance is extracted with increased efficiency.

### SUMMARY OF THE INVENTION

In order to meet this and other objects, the present invention provides, according to a first aspect, a method of preparing hot beverages by brewing up a particulate substance extractable by means of water. The method comprises the steps of filling a brewing chamber with a particulate substance, heating fresh brewing water to a temperature above the normal boiling point of water while keeping the brewing water in fluid matter of state, feeding the heated water under pressure through the particulate substance received in the brewing chamber at a temperature above the normal boiling point of water and in fluid state of matter, thereby extracting the particulate substance to create a hot beverage, and collecting the thereby prepared hot beverage and cooling it to a temperature below the normal boiling point of water.

According to a second aspect, the invention further provides an apparatus for preparing a hot beverage by brewing up a particulate substance extractable by means of water. The apparatus comprises a supply of fresh brewing water, a feed pump, a water heater adapted to heat the brewing water to a temperature above the normal boiling point of water, a brewing chamber adapted to receive a particulate substance extractable by means of the brewing water, a beverage outlet communicating with the brewing chamber, and a heat exchanger operatively inserted between the brewing chamber and the beverage outlet and adapted to cool the hot beverage brewed in the brewing chamber to a temperature below the normal boiling point of water.

Surprisingly, it has been found that the taste of the brewed beverage is not impaired at all when the beverage powder received in the brewing chamber is brewed up with brewing water having been heated to a temperature above the normal boiling point of water, but still being in fluid state of matter. The subsequent cooling is necessary to prevent the user of the beverage from injury and to ensure that the beverage leaves the machine as a liquid and not in steam form. It is understood that the extraction of the beverage powder is very efficient if water flows through it having a temperature above the normal boiling point of water.

Even if some of the discussed prior art documents mention that the coffee powder received in the brewing chamber is moistened by means of steam or water heated to more than 100° C., none of the coffee machines disclosed in those documents comprises means or measures that would allow the coffee powder received in the brewing chamber to be brewed up and extracted with water heated above the normal boiling point of water, but still being in its fluid state of matter. For this purpose, downstream the brewing chamber, both a pop or relief valve and a heat exchanger would have to be provided. If this is not the case, not a liquid beverage escapes from the beverage outlet, but simply steam.

### BRIEF DESCRIPTION OF THE DRAWINGS

In the following, an embodiment of the apparatus according to the invention will be further described, with reference to the accompanying drawing, in which a diagrammatic illustration of an apparatus for preparing a hot beverage is shown.

### DETAILED DESCRIPTION OF A PREFERRED EMBODIMENT

The single drawing shows, as mentioned above, an apparatus for preparing a hot beverage by brewing up a particulate substance extractable by means of water. The apparatus comprises a fresh water tank 1, a feed pump 2, a heat exchanger 3, a brewing chamber 4, a water heater 5, a steam conduit 7 with a steam valve 6 and a steam outlet 8, a beverage conduit 10 with a check-valve 9 and a beverage outlet 11, as well as a brewing water conduit 17 and a brewing water valve 14.

The mode of operation of such an apparatus can be described as follows, supposed that the steam valve 6 is closed and the brewing water valve 14 is open:

By means of the feed pump 2, fresh water is fed from the fresh water tank 1 through a cold water conduit 18 to the heat exchanger 3 and therefrom through a conduit 16 to the water heater 5 in which it is heated to a temperature above the normal boiling point of water. The expression “normal boiling point” defines the boiling point of pure water under normalized conditions, i.e. at an atmospheric pressure of 1013 hPa at sea level. Preferably, the water is heated in the water heater 5 to a temperature of between 110° and 130° C. The check valve 9, simultaneously operating as a relief valve, ensures that the brewing water always keeps its fluid state of matter, even if it is heated to a temperature above the normal boiling point of water.

From the water heater 5, the hot brewing water flows through a brewing water conduit 17 to the brewing chamber 4 where it flows through the substance 13 received therein such that the active ingredients of that substance 13 are extracted. Thereafter, the brewed up beverage flows by means of a conduit 19 through the heat exchanger 3 which is cooled by the fresh water; thereby, the beverage is cooled to a temperature below the normal boiling point of water. Finally, from the heat exchanger 3, the beverage flows through the check valve 9 and the beverage conduit 10 to the beverage outlet 11, where it is collected in a cup 20.

As can be seen from the drawing, the heat exchanger 3 is connected to the water heater 5 by means of heat transfer members 15. These heat transfer members 15 serve for pre-heating the heat exchanger 3 to a certain temperature. Thereby, it is possible to compensate for the heat loss caused by the plurality of elements, i.e. conduits 10, 17, brewing chamber 4, check valve 9 etc., to be heated up during the preparation of the first hot beverage. If a plurality of beverages are prepared in sequence, the above mentioned elements are already warm and the heat loss is much lower. The thermal coupling between the heat exchanger 3 and the water heater 5 takes into account these circumstance.

The steam conduit 7 is connected to the outlet of the water heater 5 by means of a T-shaped flange piece 12. In order to produce steam, the brewing water valve 14 located in the brewing water conduit 17 is closed and the steam valve 6 located in the steam conduit is opened, with the result that the water heated to a temperature above the normal boiling point of water can escape through the steam outlet 8 via the steam conduit 7. Since no check valve or relief valve is provided in the conduit 7, the water in the steam conduit, heated to a temperature above the normal boiling point of water, is in its gaseous state of matter and escapes as steam. By means of this steam, for example, a liquid contained in a cup 21 can be heated up.

Due to the fact that the substance received in the brewing chamber is brewed up by means of brewing water heated to a temperature above the normal boiling point of water, but still being in its fluid state of matter, a substantially improved extraction of the active ingredients of the substance received in the brewing chamber results, without the hitherto usual disadvantages, for example the extraction of bitter ingredients from coffee powder. Since the water is always heated up to a temperature above the normal boiling point of water in the water heater, the apparatus is always ready to deliver steam should the need arise.

The present apparatus for preparing hot beverages is particularly suitable for preparing espresso coffee. However, it is understood that other hot beverages can be prepared therewith as well, e.g. hot tea, hot chocolate beverage, hot soups and similar beverages.

What is claimed is:

1. A method of preparing a hot beverage by brewing up a particulate substance extractable by means of water, the method comprising the steps of:
providing a brewing chamber;
filling said brewing chamber with said particulate substance;
providing a supply of fresh brewing water;
heating said brewing water to a temperature above the normal boiling point of water while keeping said water in fluid matter of state;
feeding said heated water under pressure through said particulate substance received in said brewing chamber at a temperature above the normal boiling point of water and in fluid state of matter, thereby extracting said particulate substance to create a hot beverage;
collecting the thereby prepared hot beverage and cooling it to a temperature below the normal boiling point of water.

2. A method of preparing an espresso coffee beverage by brewing up ground coffee powder, the method comprising the steps of:
providing a brewing chamber;
filling said brewing chamber with said coffee powder;
providing a supply of fresh brewing water;
heating said brewing water to a temperature above the normal boiling point of water while keeping said water in fluid matter of state;
feeding said heated water under pressure through said coffee powder received in said brewing chamber at a temperature above the normal boiling point of water and in fluid state of matter, thereby extracting said coffee powder to create an espresso coffee beverage;
collecting the thereby prepared espresso coffee beverage and cooling it to a temperature below the normal boiling point of water.

3. A method according to claim 1 or 2 wherein said step of heating water to a temperature above the normal boiling point of water while keeping said water in fluid matter of state comprises the step of heating said water to a temperature above 100° C., and wherein said step of cooling the prepared beverage to a temperature below the normal boiling point of water comprises the step of cooling said beverage to a temperature of less than 100° C.

4. A method according to claim 1 or 2 wherein said step of heating water to a temperature above the normal boiling point of water while keeping said water in fluid matter of state comprises the step of keeping said heated water under an overpressure.

5. A method according to claim 1 or 2 wherein said step of heating water to a temperature above the normal boiling point of water while keeping said water in fluid matter of state comprises the step of heating said water to a temperature of between 110° and 130° C.

6. A method according to claim 1 or 2 wherein said step of collecting the thereby prepared hot beverage and cooling it to a temperature below the normal boiling point of water comprises the step of providing a heat exchanger means and leading said hot beverage through said heat exchanger means to cool it to a temperature of less than 100° C.

7. A method according to claims 1 and 6 wherein said heat exchanger means is cooled by said fresh brewing water by leading said fresh brewing water through said heat exchanger means prior to be heated to a temperature above the normal boiling point of water.

8. An apparatus for preparing a hot beverage by brewing up a particulate substance extractable by means of water, said apparatus comprising:
a supply of fresh brewing water;
a feed pump means;
a water heater means adapted to heat said brewing water to a temperature above the normal boiling point of water;
a brewing chamber means adapted to receive a particulate substance extractable by means of said brewing water;
a beverage outlet means communicating with said brewing chamber means; and
a heat exchanger means operatively inserted between said brewing chamber means and said beverage outlet means and adapted to cool said hot beverage brewed in said brewing chamber means to a temperature below the normal boiling point of water.

9. An apparatus according to claim 8, further comprising means for increasing the pressure of said brewing water, said pressure increasing means being operatively inserted between said water heater means and said beverage outlet means and adapted to keep said brewing water heated to a temperature above the normal boiling point of water in fluid matter of state.

10. An apparatus according to claim 8 in which said heat exchanger means comprises a cold water passage means and a hot water passage means, the inlet of said cold water passage means being operatively connected to said supply of fresh brewing water and the outlet of said cold water passage means being operatively connected to said water heater means.

11. An apparatus according to claim 10 in which the inlet of said hot water passage means being operatively connected to said brewing chamber means and the outlet of said hot water passage means being operatively connected to said beverage outlet means.

12. An apparatus according to claim 8, further comprising a steam conduit means operatively connected, via a valve means, to a conduit means interconnecting said water heater means and said brewing chamber means.

13. An apparatus according to claim 8, further comprising a valve means operatively inserted in a conduit means feeding hot brewing water to said brewing chamber means.

14. An apparatus according to claim 8, further comprising a relief valve means operatively inserted in a conduit means feeding the hot beverage to said beverage outlet means, said relief valve means being adapted to keep the brewing water heated to a temperature above the normal boiling point of water in fluid state of matter.

15. An apparatus according to claim 8 in which said water heater means and said heat exchanger means are thermally coupled.
